(19) United States
(12) Patent Application Publication
(10) Pub. No.: US 2025/0100453 A1
(43) Pub. Date: Mar. 27, 2025

(54) STORAGE BOX UNDER CENTRAL CONTROL SCREEN

(71) Applicant: Zhigang FAN, Guangzhou (CN)

(72) Inventor: Zhigang FAN, Guangzhou (CN)

(21) Appl. No.: 18/490,054

(22) Filed: Oct. 19, 2023

(30) Foreign Application Priority Data
Sep. 21, 2023 (CN) 2023225733114

(51) Int. Cl. B60R 5/00

(52) U.S. Cl. CPC B60R 5/00

(57) ABSTRACT

Disclosed is a storage box under a central control screen, including a box body, a storage rack, and a connecting piece, where the connecting piece has an upper end connected to one end of the storage rack and a lower end connected to one end of the box body, and the storage rack and the box body are arranged on a same side of the connecting piece and form a U-shaped clamping structure with the connecting piece; a lower end of the storage rack is provided with a connecting plate and fixedly connected to the connecting piece by the connecting plate; and a lower end surface of the connecting plate forms a V-shaped angle with an upper end surface of the box body, and the connecting piece has the same radian as the V-shaped angle. According to the storage box under the central control screen in the present application, the storage box is of an integrated structure and forms the V-shaped angle. During use, a connecting beam is directly inserted into a side edge of the central control screen and then pushed to a lower part of the central control screen. The storage box has a simple structure, is convenient to mount, and can remain stable during car driving without falling off.

### FIELD OF TECHNOLOGY

The present invention relates to the technical field of car accessory equipment, in particular to a storage box under a central control screen.

### BACKGROUND

With the development of society, cars are becoming increasingly important to people's lives, and people has higher requirements for structures and space utilization of the cars. Nowadays, storage spaces with box covers are provided in central control positions of cars. Therefore, drivers are required to open the box covers manually to place or take items, and especially during driving, opening or closing the box covers will distract the driver's attention. At present, there is also a storage rack placed above a connecting beam of a central control screen on the market. However, such storage rack is fixed below the connecting beam of the central control screen by magnetic suction, making it insufficient in connection strength, poor in load-bearing capacity, and prone to falloff.

### SUMMARY

An objective of the present invention is to provide a storage box under a central control screen, to solve the problems raised in the above background.

To solve the above technical problems, the present invention adopts the following technical solution:

A storage box under a central control screen includes a box body, a storage rack, and a connecting piece. The connecting piece has an upper end connected to one end of the storage rack and a lower end connected to one end of the box body, and the storage rack and the box body are arranged on a same side of the connecting piece and form a U-shaped clamping structure with the connecting piece. The storage box may be fixed to a predetermined position by pushing horizontally along an opening direction of the U-shaped clamping structure. A lower end of the storage rack is provided with a connecting plate and fixedly connected to the connecting piece by the connecting plate; and a lower end surface of the connecting plate forms a V-shaped angle with an upper end surface of the box body, and the connecting piece has the same radian as the V-shaped angle. The entire storage box forms a V-shaped concave surface with a radian adapted to a protruding surface of a car center console to be mounted. During use, a side, close to the center console, of the storage box is attached to the center console, such that the storage box may be provided with more support to have stronger load-bearing capacity on one hand and is more attractive on the other hand.

Further, the storage box is integrally formed, such that assembly is not required and loss of parts is avoided.

Further, an accommodating cavity of the box body is in a V shape with a small bottom and a large opening, such that space utilization is maximized while it is convenient for taking. During use, a lower end surface of the box body is horizontally arranged or an opening end of the lower end surface of the box body is higher than a connecting end of the lower end surface of the box body, such that an item in the box body may be prevented from sliding out or falling off.

Further, the storage rack is provided with a magnetic suction sheet, and a magnetic suction region is formed on the storage rack.

Further, a corresponding ratio of a length of connection between the box body/the storage rack and the connecting piece to a length of the box body/the storage rack is (1-3):10.

Further, the storage box is made of a plastic.

The beneficial effects are as follows:

According to the storage box under the central control screen in the present application, the entire storage box is of an integrated structure and forms the V-shaped angle. During use, a connecting beam of the central control screen is directly inserted into a side edge of the central control screen and then pushed to a lower part of the central control screen. The storage box has a simple structure, is convenient to mount, and can remain stable during car driving without falling off.

### BRIEF DESCRIPTION OF THE DRAWINGS

FIG. 1 is a schematic diagram of an overall structure of the present invention;

FIG. 2 is a front view of the present invention;

FIG. 3 is a back view opposite to FIG. 2;

FIG. 4 is a top view of the present invention; and

FIG. 5 is a side view of the present invention.

In the drawings: 1. storage rack; 2. box body; 3. connecting piece; 4. magnetic suction sheet; 5. connecting plate; and 6. U-shaped clamping structure.

### DESCRIPTION OF THE EMBODIMENTS

The present invention is further described in detail below in conjunction with the accompanying drawings and the specific embodiments.

### Embodiment

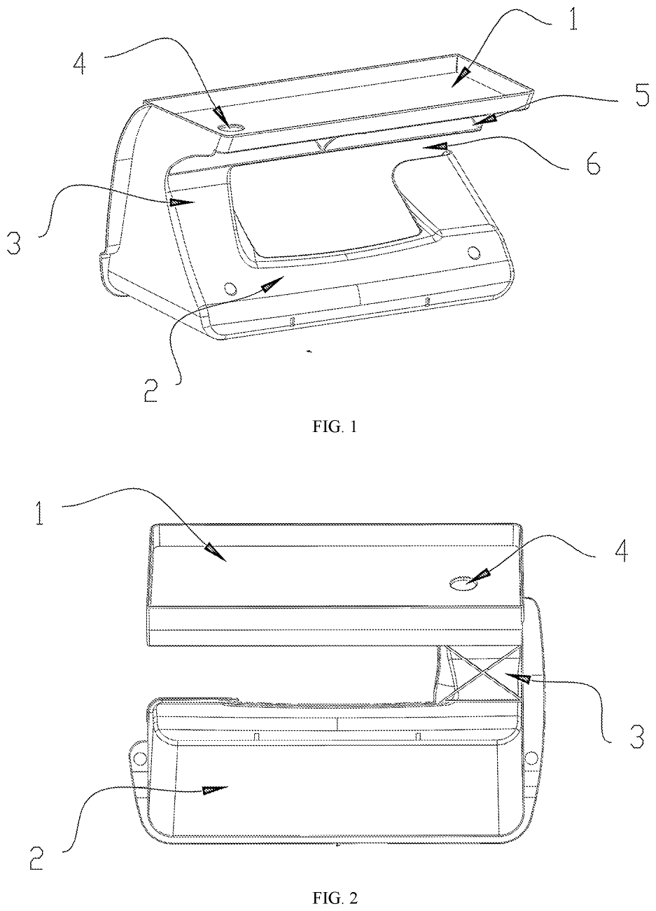

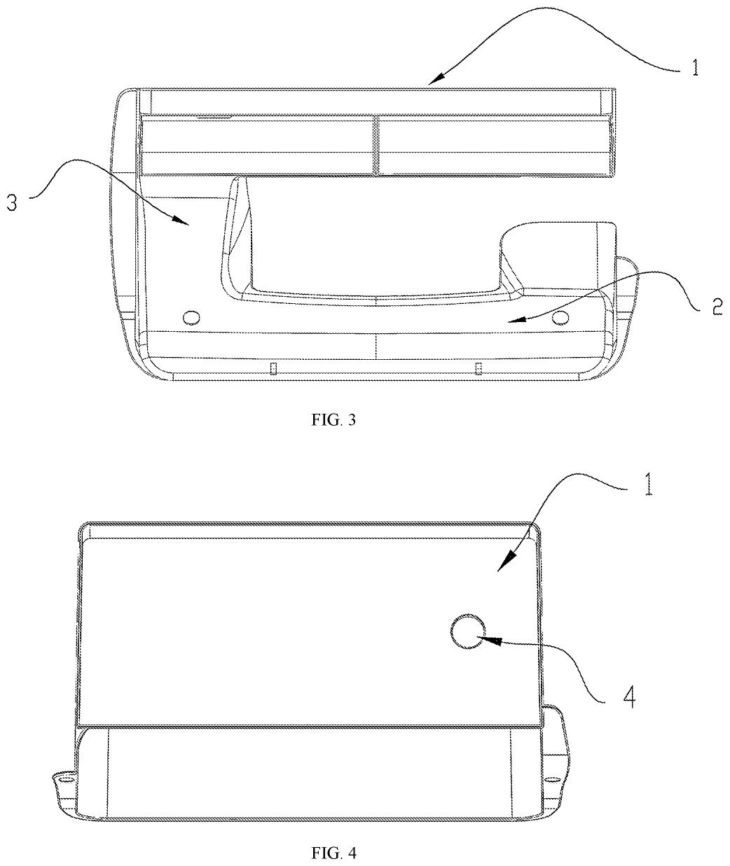

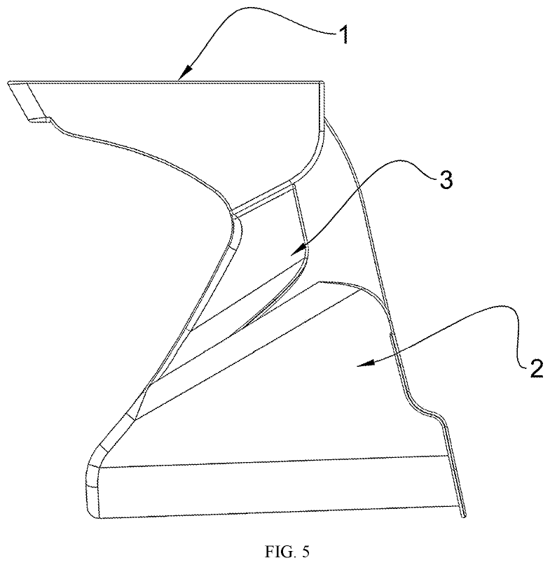

As shown in FIG. 1 to FIG. 5, a storage box under a central control screen includes a box body 2, a storage rack 1, and a connecting piece 3. The connecting piece 3 has an upper end connected to one end of the storage rack 1 and a lower end connected to one end of the box body, the storage rack 1 and the box body 2 are arranged on a same side of the connecting piece 3 and form a U-shaped clamping structure 6 with the connecting piece, and a lower end of the storage rack is provided with a connecting plate 5 and fixedly connected to the connecting piece 3 by the connecting plate 5. A lower end surface of the connecting plate 5 forms a V-shaped angle with an upper end surface of the box body 2, and the connecting piece 3 has the same radian as the V-shaped angle.

As a preferred solution, the entire storage box forms a V-shaped concave surface with a radian adapted to a protruding surface of a car center console to be mounted. During use, a side, close to the center console, of the storage box is attached to the center console, such that the storage box may be provided with more support to have stronger load-bearing capacity on one hand and is more attractive on the other hand.

This product does not need to be assembled. During use, the present application is inserted into a connecting beam on a side edge of the central control screen and then pushed to a lower part of the central control screen. Specifically, because a cross section of the connecting piece 3 is in a V shape adapted to the connecting beam of the central control screen, the connecting piece may be directly inserted into the connecting beam on the side edge of the central control screen. In this case, a bottom of the connecting plate 5 abuts against an upper plate surface of the connecting beam of the central control screen, and the upper end surface of the box body 2 abuts against a lower plate surface of the connecting beam of the central control screen. Then, the storage box is horizontally pushed to the lower part of the central control screen, such that the central control screen is exactly clamped between the box body 2 and the storage rack 1. In this way, the central control screen is not blocked, and the connecting plate makes it convenient for a car driver to directly take or place an item during car driving. Moreover, the connecting piece 3 has a certain width, which increases an area of contact between the storage box and the connecting beam of the central control screen to make a stress more uniform and stable, so the storage box may be stably hung on the connecting beam. A corresponding ratio of a length of connection between the box body/the storage rack and the connecting piece to a length of the box body/the storage rack is (1-3):10.

Preferably, the storage box is integrally formed, such that the box body 2 does not fall off due to the too heavy placed item.

Preferably, an accommodating cavity of the box body 2 is in a V shape with a small bottom and a large opening, such that space utilization is maximized while it is convenient for taking. During use, a lower end surface of the box body is horizontally arranged or an opening end of the lower end surface of the box body is higher than a connecting end of the lower end surface of the box body, such that the item in the box body may be prevented from sliding out or falling off, a user may be allowed to place a mobile phone, a paper towel, or other sundries, and the storage box remains stable during car driving without falling off.

Preferably, the storage rack 1 is provided with a magnetic suction sheet, and a magnetic suction region is formed on the storage rack, such that the user may place an electronic toll collection (ETC) card with magnetic suction or other items with magnetic suction more firmly.

Preferably, the storage box is made of a plastic. Because the plastic has a certain toughness, when the storage box is inserted into the connecting beam of the central control screen, if an angle or a position is inappropriate and needs to be adjusted, the position may be directly adjusted to the best position without worrying about damage.

While the embodiments of the present invention has been described in the specification, these embodiments only serve as hints and should not limit the scope of protection of the present invention. Various omissions, substitutions, and modifications made within departing from the scope of the present invention shall be all included within the scope of protection of the present invention.

1. A storage box under a central control screen, comprising a box body, a storage rack, and a connecting piece, wherein the connecting piece has an upper end connected to one end of the storage rack and a lower end connected to one end of the box body, and the storage rack and the box body are arranged on a same side of the connecting piece and form a U-shaped clamping structure with the connecting piece; a lower end of the storage rack is provided with a connecting plate and fixedly connected to the connecting piece by the connecting plate; and a lower end surface of the connecting plate forms a V-shaped angle with an upper end surface of the box body, and the connecting piece has the same radian as the V-shaped angle.

2. The storage box under a central control screen according to claim 1, wherein the storage box is integrally formed.

3. The storage box under a central control screen according to claim 1, wherein an accommodating cavity of the box body is V-shaped, and during use, a lower end surface of the box body is horizontally arranged or an opening end of the lower end surface of the box body is higher than a connecting end of the lower end surface of the box body.

4. The storage box under a central control screen according to claim 1, wherein the storage rack is provided with a magnetic suction sheet.

5. The storage box under a central control screen according to claim 1, wherein a corresponding ratio of a length of connection between the box body/the storage rack and the connecting piece to a length of the box body/the storage rack is (1-3):10.

6. The storage box under a central control screen according to claim 1, wherein the storage box is made of a plastic.
